(19) United States
(12) Patent Application Publication
(10) Pub. No.: US 2008/0282330 A1
(43) Pub. Date: Nov. 13, 2008

(54) BLUETOOTH DEVICE CONNECTION METHOD AND RELATED BLUETOOTH DEVICE

(76) Inventor: Wei-Kun Su, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/116,939

(22) Filed: May 7, 2008

(30) Foreign Application Priority Data
May 8, 2007 (TW) 096116260

(51) Int. Cl. H04L 9/32

(52) U.S. Cl. 726/5

(57) ABSTRACT

The present invention provides a bluetooth device connection method. The bluetooth device connection method includes: acquiring a device list, the device list at least records a bluetooth device; assigning a bluetooth device belonging to a target class in the device list as a target device; determining whether the target device authorizes a match password; and utilizing the match password to build a connection with the target device if the target device authorizes the match password.

### BACKGROUND OF THE INVENTION

1. Field of the Invention

The present invention relates to a bluetooth device, and more particularly, to a bluetooth device connection method and related bluetooth device.

2. Description of the Prior Art

To connect an electronic device operated by a user to another electronic device wirelessly within a certain distance, Bluetooth communication is one of the most popular short-distance wireless technologies presently and has advantages of saving conventional physical connection wires and avoiding accompanying inconvenience. For user data security, the Bluetooth special interest group (Bluetooth SIG) defines a considerably strict verification mechanism that requires execution of several steps with some corresponding passwords by users. However, such a mechanism not only consumes lots of time, but also greatly degrades convenience of bluetooth devices in practical use. Therefore, it is desirable to provide an improved bluetooth device connection method.

### SUMMARY OF THE INVENTION

It is therefore one of the objectives of the present invention to provide a bluetooth device connection method and related bluetooth device to solve the above mentioned problems.

The present invention discloses a bluetooth device connection method, comprising: acquiring a device list, the device list at least records a bluetooth device; assigning a bluetooth device belonging to a target class in the device list as a target device; determining whether the target device authorizes a match password; and utilizing the match password to build a connection with the target device if the target device authorizes the match password.

The present invention also discloses a bluetooth device, comprising: a detecting unit, for acquiring a device list and at least a match password, wherein the device list at least records a bluetooth device; an assigning unit, coupled to the detecting unit, for assigning a bluetooth device belonging to a target class in the device list as a target device; and a controlling unit, coupled to the detecting unit and the assigning unit, for determining whether the target device authorizes the match password, wherein the controlling unit utilizes the match password to build a connection with the target device when the controlling unit determines that the target device authorizes the match password.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic block diagram illustrating an embodiment of a bluetooth device of the present invention.

FIG. 2 is a flowchart illustrating an embodiment of a bluetooth device connection method of the present invention.

### DETAILED DESCRIPTION

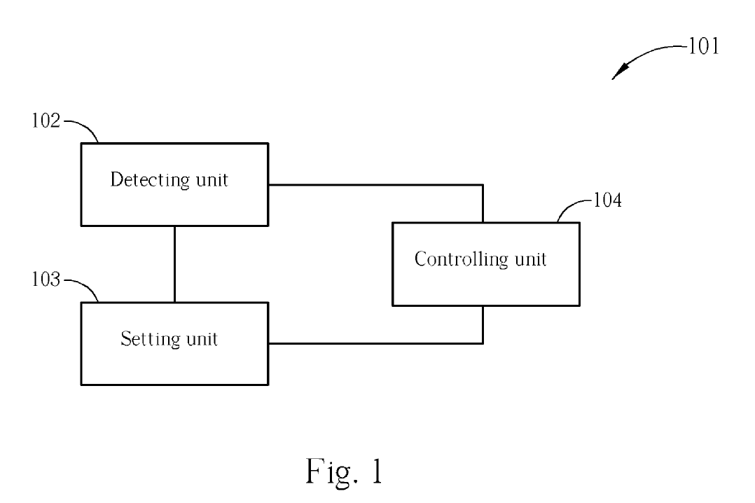

FIG. 1 a schematic block diagram illustrating an embodiment of a bluetooth device 101 of the present invention. As shown in FIG. 1, the bluetooth device 101 comprises a detecting unit 102, an assigning unit 103, and a controlling unit 104. The assigning unit 103 is coupled to the detecting unit 102. The controlling unit 104 is coupled to the detecting unit 102 and the assigning unit 103. In this embodiment, the bluetooth device 101 is a mobile phone having bluetooth functionality. This example is not meant to be a limitation of the present invention, however. Please note that the bluetooth device 101 has more components, but only the components related to the present invention are shown in FIG. 1.

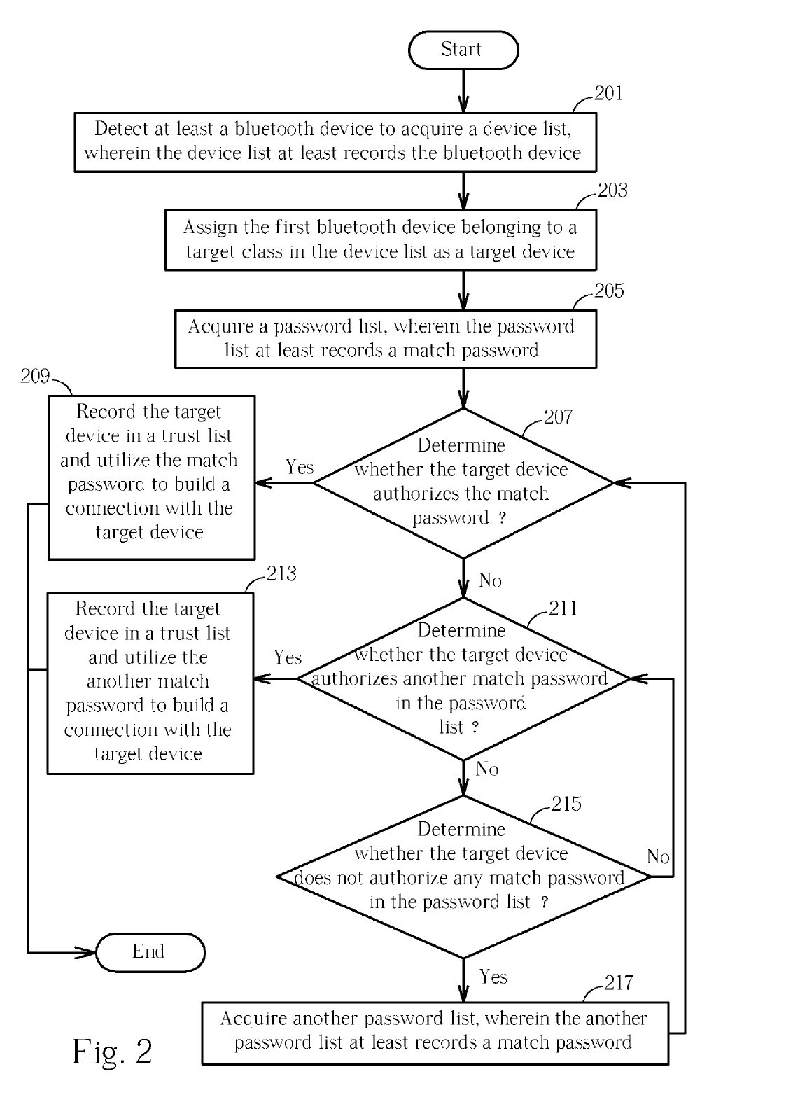

FIG. 2 is a flowchart illustrating an embodiment of a bluetooth device connection method of the present invention. As shown in FIG. 2, the bluetooth device connection method comprises the following steps:

STEP 201: Detect at least a bluetooth device to acquire a device list, wherein the device list at least records the bluetooth device;

STEP 203: Assign the first bluetooth device belonging to a target class in the device list as a target device;

STEP 205: Acquire a password list, wherein the password list at least records a match password;

STEP 207: Determine whether the target device authorizes the match password? If so, proceed to STEP 209; if not, proceed to STEP 211;

STEP 209: Record the target device in a trust list and utilize the match password to build a connection with the target device (the process ends herein);

STEP 211: Determine whether the target device authorizes another match password in the password list? If so, proceed to STEP 213; if not, proceed to STEP 215;

STEP 213: Record the target device in a trust list and utilize the another match password to build a connection with the target device (the process ends herein);

STEP 215: Determine whether the target device does not authorize any match password in the password list? If so, proceed to STEP 217; if not, return to STEP 211; and

STEP 217: Acquire another password list, wherein the another password list at least records a match password, and then return to STEP 207 for processing the match password in the another password list.

The details as to how the bluetooth device 101 in FIG. 1 performs the bluetooth device connection method in FIG. 2 are described as follows.

First, the detecting unit 102 sends out a search signal for at least detecting another bluetooth device to further acquire a corresponding device list, wherein the device list at least records the another bluetooth device (STEP 201). Next, the assigning unit 103 assigns the first bluetooth device belonging to a target class in the device list as a target device (STEP 203). In this embodiment, the target class corresponds to earphones, so the assigned first bluetooth device is a bluetooth earphone. This example is not meant to be a limitation of the present invention, however. Then, the detecting unit 102 acquires a password list, wherein the password list at least records a match password (STEP 205). Additionally, in this embodiment, the password list is stored in the bluetooth device 101 in advance to be read by the detecting unit 102. Match passwords recorded in the password list are “0000”, “1234”, “4444”, and “8888” sequentially.

Next, the controlling unit 104 determines whether the target device authorizes a match password in the in the password list (STEP 207). Additionally, in this embodiment, the controlling unit 104 sends the first match password (i.e. “0000”) in the password list to the target device wirelessly for the target device to verify whether the first match password is valid. If the first match password is valid, the target device will send a confirmation signal to the controlling unit 104 for indicating that the target device has authorized the first match password. Then, the process proceeds to the next step, where the controlling unit 104 records the target device in a trust list and utilizes the valid match password (i.e. the first match password “0000”) to build a connection with the target device (STEP 209). The whole process ends herein.

Contrarily, if the controlling unit 104 determines in STEP 207 that the target device does not authorize the first match password (i.e. “0000”) in the password list, the process will proceed to another step, where the controlling unit 104 will determine whether the target device authorizes another match password in the password list (STEP 211). Specifically, in this embodiment, the controlling unit 104 determines whether the target device authorizes the next match password (i.e. the second match password “1234”) in the password list. If the controlling unit 104 determines in STEP 211 that the target device authorizes the second match password (i.e. “1234”), the process will proceed to the next step, where the controlling unit 104 will record the target device in a trust list and utilize the second match password to build a connection with the target device (STEP 213). The whole process ends herein.

Contrarily, if the controlling unit 104 determines in STEP 211 that the target device does not authorize the second match password (i.e. “1234”), the process will proceed to another step, where the controlling unit 104 will determine whether the target device does not authorize any match password in the password list (STEP 215). Specifically, in this embodiment, the controlling unit 104 determines whether the target device authorizes any match password in the password list one by one. Thus, when the controlling unit 104 determines that the target device does not authorize the last match password in the password list, it means that the target device does not authorize all match passwords in the password list. Additionally, after the controlling unit 104 determines in STEP 215 that the target device does not authorize any match password in the password list, the process proceeds to the next step, where the controlling unit 104 controls the detecting unit 102 to acquire another password list, wherein the another password list at least records a match password (STEP 217). Additionally, in this embodiment, the another password list is input manually by a user and thus is not stored in the bluetooth device 101 in advance. Specifically, if the controlling unit 104 cannot achieve automatic matching as described above according to the password list pre-stored in the bluetooth device 101, the bluetooth device 101 will display a conventional password input screen for the user to input a new match password. For example, if the user inputs “9999” on the password input screen, a new match password “9999” will be recorded in the another password list. Please note that, in this embodiment, the user can input one or more match password into the another password list according to practical requirements. After STEP 217 is performed, the process returns to STEP 207 for processing the match password(s) in the another password list.

Contrarily, if the condition in STEP 215 is not established, the process will return to STEP 211, where the controlling unit 104 will determine whether the target device authorizes another match password not yet processed in the password list. Specifically, in this embodiment, the controlling unit 104 determines whether the target device authorizes the next match password (i.e. the third match password “4444”) in the password list. As described above, in this embodiment, the controlling unit 104 determines whether the target device authorizes any match password in the password list one by one.

Please note that although the detecting unit 102, the assigning unit 103, and the controlling unit 104 are separate hardware units as shown in FIG. 1, this is not meant to be a limitation of the present invention. For example, the assigning unit 103 can also be an internal component of the controlling unit 104. Additionally, the functionality of the detecting unit 102, the assigning unit 103, and the controlling unit 104 can also be accomplished utilizing programmable codes. In such a case, the above bluetooth device connection method can be achieved by software. Specifically, in an embodiment of the present invention, the controlling unit 104 executes firmware stored in a storing unit of any feasible form to achieve the above bluetooth device connection method. The storing unit can be, for example, a static random access memory (SRAM) or any other appropriate memory, and the controlling unit 104 can be a microprocessor for executing firmware stored in the storing unit.

In an embodiment of the present invention, an assigning unit can select a desired bluetooth device from a device list automatically according to an appropriate condition. Thus, the desired bluetooth device is not required to be selected manually by a user. Additionally, a controlling unit can select a desired match password from a password list automatically for performing matching with a target device. Thus, the desired match password is not required to be input manually by the user. Accordingly, to connect a bluetooth device to another bluetooth device, the user only needs to perform one step. Specifically, the user only needs to make the bluetooth device execute a searching function, and then the bluetooth device can find the another bluetooth device desired by the user automatically and further connect to the another bluetooth device automatically. Consequently, utilizing the bluetooth device and the bluetooth device connection method as disclosed in the present invention, manual operating time and steps by the user can be greatly decreased, thereby improving convenience of the bluetooth device in practical use.

Those skilled in the art will readily observe that numerous modifications and alterations of the device and method may be made while retaining the teachings of the invention.

What is claimed is:

1. A bluetooth device connection method, comprising:
acquiring a device list, the device list at least records a bluetooth device;
assigning a bluetooth device belonging to a target class in the device list as a target device;
determining whether the target device authorized a match password; and
utilizing the match password to build a connection with the target device if the target device authorizes the match password.

2. The method of claim 1, wherein the match password is recorded in a password list.

3. The method of claim 2, further comprising:
determining whether the target device authorized any other match password in the password list one by one if the target device does not authorize the match password; and
utilizing another match password in the password list to build a connection with the target device if the target device authorizes the another match password.

4. The method of claim 1, wherein the step of acquiring the device list comprises:
detecting at least a bluetooth device to acquire the device list.

5. The method of claim 1, wherein the step of assigning the bluetooth device belonging to the target class in the device list as the target device comprises:
assigning the first bluetooth device belonging to the target class in the device list as the target device.

6. The method of claim 1, wherein the step of utilizing the match password to build a connection with the target device comprises:
recording the target device in a trust list and utilizing the match password to build a connection with the target device if the target device authorizes the match password.

7. A bluetooth device, comprising:
a detecting unit, for acquiring a device list and at least a match password, wherein the device list at least records a bluetooth device;
an assigning unit, coupled to the detecting unit, for assigning a bluetooth device belonging to a target class in the device list as a target device; and
a controlling unit, coupled to the detecting unit and the assigning unit, for determining whether the target device authorized the match password, wherein the controlling unit utilizes the match password to build a connection with the target device when the controlling unit determines that the target device authorizes the match password.

8. The device of claim 7, wherein the detecting unit utilizes a password list to record the match password.

9. The device of claim 8, wherein the controlling unit determines whether the target device authorizes any other match password in the password list one by one when the controlling unit determines that the target device does not authorize the match password, and wherein the controlling unit utilizes another match password in the password list to build a connection with the target device when the controlling unit determines that the target device authorizes the another match password.

10. The device of claim 7, wherein the detecting unit detects at least a bluetooth device to acquire the device list.

11. The device of claim 7, wherein the assigning unit assigns the first bluetooth device belonging to the target class in the device list as the target device.

12. The device of claim 7, wherein the controlling unit records the target device in a trust list and utilizes the match password to build a connection with the target device when the controlling unit determines that the target device authorizes the match password.
